(19) United States
(12) Patent Application Publication
(10) Pub. No.: US 2014/0243077 A1
(43) Pub. Date: Aug. 28, 2014

(54) APPARATUS AND METHOD OF ANALYZING GAME CHARACTERISTICS/ATTRIBUTES FOR CHEATING USER DETECTION USING GAME CHARACTERISTICS/ATTRIBUTES

(71) Applicant: Electronics and Telecommunications Research Institute, Daejeon (KR)

(72) Inventor: Yeon Jun CHOI, Daejeon (KR)

(73) Assignee: Electronics and Telecommunications Research Institute, Daejeon (KR)

(21) Appl. No.: 14/098,150

(22) Filed: Dec. 5, 2013

(30) Foreign Application Priority Data
Feb. 27, 2013 (KR) 10-2013-0020959

(51) Int. Cl. A63F 13/00

(52) U.S. Cl. CPC A63F 13/00
USPC 463/29

(57) ABSTRACT

An apparatus for analyzing a game characteristic is disclosed, the apparatus including a log data generation unit to preprocess a log of game play details of game users, and generate log data, a characteristics analysis unit to extract a game resource attribute of the log data, and analyze game resource characteristics of the game users, and an cheating user detection unit to detect an cheating user among the game users using the game resource characteristics and a parameter based on the log data.

### CROSS-REFERENCE TO RELATED APPLICATION

This application claims the priority benefit of Korean Patent Application No. 10-2013-0020959, filed on Feb. 27, 2013, in the Korean Intellectual Property Office, the disclosure of which is incorporated herein by reference.

### BACKGROUND

1. Field

The present invention relates to an apparatus and a method of analyzing game characteristics/attributes for cheating user detection using game characteristics/attributes, and more particularly, to an apparatus and a method of analyzing game characteristics/attributes that detect an cheating user using a log occurring when a game user uses a game.

2. Description of Related Art

Generally, an online game is played by a large number of game users via accessing a server. Here, the game users acquire goods, weapon and medicinal herbs used for the online game through a play. However, cheating users who acquire goods in an illegal manner, not in a normal manner, may exist among the game users of the online game.

Thus, an online game administrator detects cheating users using various cheating user detection schemes, for example, by installing a function of detecting a hacking virus or worm on a game user, frequently changing a protocol or encoding.

However, as an cheating user finds a detour route against an cheating user detection method in a short time to use the online game, preventing the cheating user from acquiring goods in an illegal manner may be difficult.

### SUMMARY

An aspect of the present invention provides a game characteristics/attributes analysis apparatus that analyzes a log of game play details or play results of a game user to effectively detect an cheating user that acquires goods in an illegal manner.

Another aspect of the present invention also provides a game characteristics/attributes analysis apparatus that extracts characteristics of a game played by a game user and characteristics of the game user via analysis of a log to recognize characteristics of a normal user and an cheating user, thereby easily detecting an cheating user hiding among game users.

According to an aspect of the present invention, there is provided an apparatus for analyzing a game characteristic, the apparatus including a log data generation unit to preprocess a log of game play details of game users to generate log data, a characteristics analysis unit to extract a game resource attribute of the log data to analyze game resource characteristics of the game users, and an cheating user detection unit to detect an cheating user of the game users using the game resource characteristics and the log data.

The log data generation unit may preprocess the log using at least one of noise reduction, data sorting, data format conversion and filling a blank item of data.

The characteristics analysis unit may extract the game resource attribute that occurs in a process that the game users play a game from a log item of the log data.

The game resource attribute may include at least one of goods acquired or changed in holding state via a direct play including at least one of hunting, picking, dumping, collecting, dealing, selling, purchasing and producing that occur while the game users play a game, attributes and changes due to goods changed in holding state by acquiring and dumping, geographic features and natural features.

The characteristics analysis unit may analyze the game resource characteristics related to an attribute for categorizing the game users as a cluster that the game users belong to.

The cheating user detection unit may extracts a characteristic of a normal user based on attributes of the game users.

The attributes of the game users may include at least one of state settings and variable properties among a number of characters of the game users, occupations of the characters, ability of the characters to move, physical fitness, power, skills, an affiliated group in game, a connection state, interaction, a party, a guild and a raid.

The attributes of the game users may include an attribute for categorizing the game users as a cluster that the game users belong to.

The cheating user detection unit may set up a function of comparing a characteristic of the cheating user with the characteristic of the normal user and extract a threshold and a parameter for adjusting the function.

According to an aspect of the present invention, there is provided a method of analyzing a game characteristic, the method including preprocessing a log of game play details of game users to generate log data, extracting a game resource attribute of the log data to analyze game resource characteristics of the game users, and detecting an cheating user of the game users using the game resource characteristics and the log data.

The generating of the log data may preprocess the log using at least one of noise reduction, data sorting, data format conversion and filling a blank item of data.

The analyzing of the game resource characteristics may extract the game resource attribute that occurs in a process that the game users play a game from a log item of the log data.

The game resource attribute may include at least one of goods acquired or changed in holding state via a direct play including at least one of hunting, picking, dumping, collecting, dealing, selling, purchasing and producing that occur while the game users play a game, attributes and changes due to goods changed in holding state by acquiring and dumping, geographic features and natural features.

The analyzing of the game resource characteristics may analyze the game resource characteristics related to an attribute for categorizing the game users as a cluster that the game users belong to.

The detecting of the cheating user may extract a characteristic of a normal user based on attributes of the game users.

The attributes of the game users may include at least one of state settings and variable properties among a number of characters of the game users, occupations of the characters, ability of the characters to move, physical fitness, power, skills, an affiliated group in game, a connection state, interaction, a party, a guild and a raid.

The attributes of the game users may include an attribute for categorizing the game users as a cluster that the game users belong to.

The detecting of the cheating user may set up a function of comparing a characteristic of the cheating user with the characteristic of the normal user and extract a threshold and a parameter for adjusting the function.

As described above, a game characteristics/attributes analysis apparatus according to an exemplary embodiment may analyze a log of game play details or play results of a game user to effectively detect an cheating user that acquires goods in an illegal manner.

A game characteristics/attributes analysis apparatus according to an exemplary embodiment extracts characteristics of a game played by a game user and characteristics of the game user via analysis of a log to recognize characteristics of a normal user and an cheating user, thereby easily detecting an cheating user hiding among game users.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a game characteristics/attributes analysis apparatus according to an exemplary embodiment;

FIG. 2 illustrates a detailed configuration of a game characteristics/attributes analysis apparatus according to an exemplary embodiment;

FIG. 3 illustrates a game resource attribute according to an exemplary embodiment;

FIG. 4 illustrates characteristics of a normal user and an cheating user according to an exemplary embodiment; and

FIG. 5 illustrates a game characteristics/attributes analysis method according to an exemplary embodiment.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

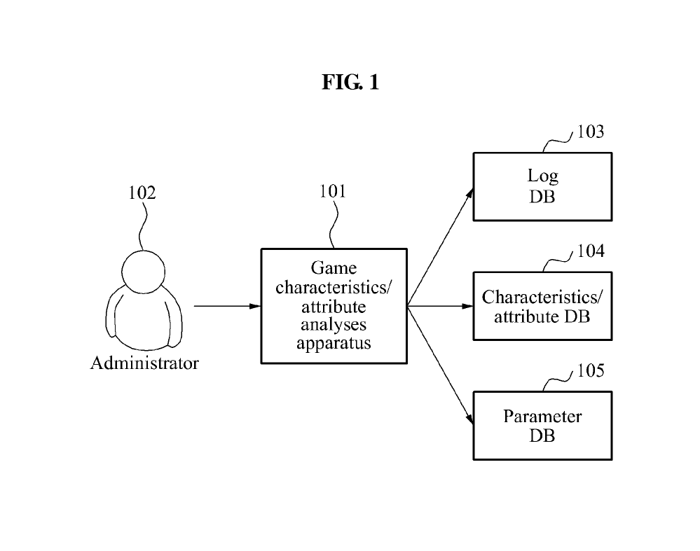

FIG. 1 illustrates a game characteristics/attributes analysis apparatus according to an exemplary embodiment.

Referring to FIG. 1, the game characteristics/attributes analysis apparatus 101 may analyze a log of game play details or play results of a game user.

In detail, the game characteristics/attributes analysis apparatus 101 may extract a log of a game user from a log database (DB) 103. The log database (DB) means log data storage which includes log data file or log data stored DBMS. Here, the game characteristics/attributes analysis apparatus 101 may extract the log of the game user stored in the log DB 10 according to a control instruction of an administrator to analyze the log of the game user. Here, the log DB 103 may record game play details or play results of game users using games. The log DB 103 may include log items for recording play details or play results. For example, the log DB 103 may include a log item for recording game play details or play results, such as hunting, picking, dumping, dealing, selling and trading.

The game characteristics/attributes analysis apparatus 101 may analyze the log to extract characteristics of a game or the game user. The game characteristics/attributes analysis apparatus 101 may preprocess the log to extract the characteristics of the game and the game user, thereby generating log data. Preprocessing is data refinement which may include sorting, deleting or converting the log data to make easier detecting a cheating user among game users. The game characteristics/attributes analysis apparatus 101 may extract characteristics of the game, such as a game environment including specifications of graphics and sounds, and characteristics of a game resource including an item, for use of the game using the log data. Here, the game characteristics/attributes analysis apparatus 101 may extract the characteristics of the game using an application program interface (API) of the log data with the log preprocessed in advance or using the log data generated by preprocessing the log.

The game characteristics/attributes analysis apparatus 101 may analyze the log of the game play details or play results of the game user to extract characteristics of the game user, such as a number of characters of the game user and occupations of the characters.

The extracted characteristics of the game and the game user may be stored in a characteristics/attribute DB 104. The characteristics/attribute DB 104 may store the game environment, the game resource characteristics and the characteristics of the game user which are extracted using the log data.

Further, the game characteristics/attributes analysis apparatus 101 may distinguish a normal user from an cheating user among game users based on the characteristics of the game user included in the game play details or play results of the game user. In detail, the game characteristics/attributes analysis apparatus 101 may set up a function of distinguishing a characteristic value of the cheating user using the characteristics of the game user. The game characteristics/attributes analysis apparatus 101 may extract a threshold and a parameter for adjusting the function. Here, the threshold and the parameter may be based on a characteristics value of the normal user among the game users. That is, since the game characteristics/attributes analysis apparatus 101 may need to extract the cheating user playing the game in a different manner from the normal user playing the game in a normal manner, the threshold and the parameter of the function for extracting the cheating user may be based on the characteristic value of the normal user.

The game characteristics/attributes analysis apparatus 101 may store the extracted parameter in a parameter DB 105. The parameter DB 105 may store an adjusted value of the function used to detect the cheating user.

The game characteristics/attributes analysis apparatus 101 may detect the cheating user among the game users using the function.

The log DB 103, the characteristics/attribute DB 104 and the parameter DB 105 may be connected with the game characteristics/attributes analysis apparatus 101 via a network or a data transmission cable or be present in the game characteristics/attributes analysis apparatus 101. The log DB 103, the characteristics/attribute DB 104 and the parameter DB 105 are not constructed as being limited to a DB but may be a memory to store the log of the game user, the log data, characteristics based on the log data and the parameter.

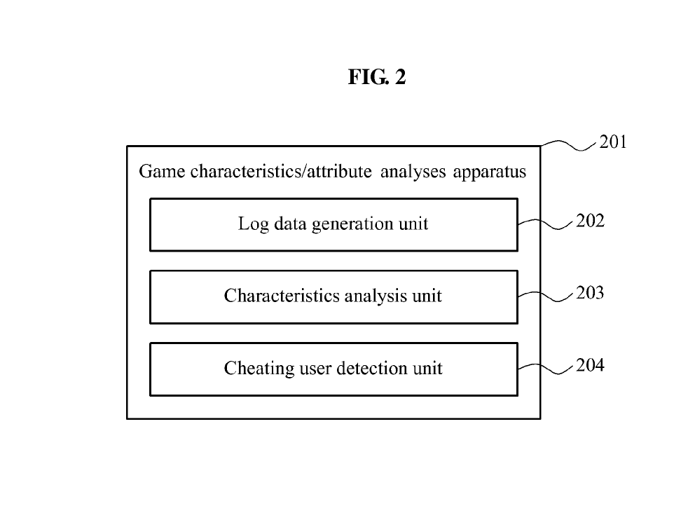

FIG. 2 illustrates a detailed configuration of a game characteristics/attributes analysis apparatus according to an exemplary embodiment.

Referring to FIG. 2, the game characteristics/attributes analysis apparatus 201 may include a log data generation unit 202, a characteristics analysis unit 203 and an cheating user detection unit 204.

The log data generation unit 202 may preprocess a log of game play details or play results that occur when a game user plays a game to generate log data. Here, the log may include a log item recording the game play details or play results, such as hunting, picking, dumping, dealing, selling and trading.

The log data generation unit 202 may preprocess the log using noise reduction, data sorting or data format conversion, thereby generating the log data. In detail, the log data generation unit 202 may perform noise reduction by removing unnecessary data or items in the log, incorrectly recorded data or items in the log, and data or items disturbing detection of an cheating user. The log data generation unit 202 may perform data format conversion by filling a blank item of data to adjust a data format. For example, data format conversion may be performed by filling a blank item of data with a preset character or character string, thereby converting a data format.

That is, the log data generation unit 202 may remove noise included in the log, arrange data in the log and convert a format of the data to generate the log data, thereby generating basic data for detecting an cheating user among game users.

The characteristics analysis unit 203 may extract a game resource attribute of the log data to analyze a game resource characteristic of the game user. In detail, the characteristics analysis unit 203 may extract the game resource attribute that occurs in a process that the game user plays the game from the log item of the log data. The game resource attribute may refer to an attribute value of a game resource according to the log item. That is, the game resource attribute may include goods acquired or changed in holding state via a direct play including at least one of hunting, picking, dumping, collecting, dealing, selling, purchasing and producing that occur while the game user plays the game, attributes and changes due to goods changed in holding state by acquiring and dumping, geographic features and natural features. For instance, the game resource attribute may include an attribute value of a game resource acquired by the game user through a play according to a log item “Hunt monster: +5” of a log item “Hunting.”

The characteristics analysis unit 203 may analyze a game resource characteristic related to an attribute value for categorizing the game user as a cluster that the game user belongs to. Here, categorizing the game user as the cluster that the game user belongs to may be categorizing the game user according to similarity based on characteristics of the game user. For example, the game user may be categorized as the cluster that the game user belongs to according to similarity in a character of the game user and an occupation of the character. Further, a game resource characteristic may be distinguished from a game resource attribute and be a feature to categorize the game user.

The cheating user detection unit 204 may extract a characteristic of a normal user among game users by using an attribute of the game user. The cheating user detection unit 204 may extract a characteristic of an cheating user based on the characteristic of the normal user. In detail, the cheating user detection unit 204 may extract of the characteristic of the normal user based on the attribute of the game user. The attribute of the game user may be at least one of state settings and variable properties among a number of characters of the game user, occupations of the characters, ability of the characters to move, physical fitness, power, skills, an affiliated group in game, a connection state, interaction, a party, a guild and a raid. Further, the attribute of the game user may include an attribute for categorizing the game user as the cluster that the game user belongs to. Also, the attribute of the game user may include the characteristic of the normal user that is a general property of the game user playing the game.

The cheating user detection unit 204 may set up a function of comparing the characteristic of the cheating user using the game resource characteristic for categorizing the game user as each cluster and the preprocessed log data. Here, the cheating user detection unit 204 may set up a function of comparing the characteristic of the normal user and the characteristic of the cheating user. The cheating user detection unit 204 may compare the characteristic of the normal user and the characteristic of the cheating user using various schemes, for example, a statistical scheme, without being limited to the function.

The cheating user detection unit 204 may set up a threshold and a parameter for adjusting the function or statistical scheme. Here, the threshold and the parameter may be set up based on the characteristic of the normal user. The cheating user detection unit 204 may adjust the function based on the threshold and parameter, thereby detecting an cheating user among game users. For example, when the game user exceeds the threshed and parameter of the function, the cheating user detection unit 204 may detect the game user as an cheating user.

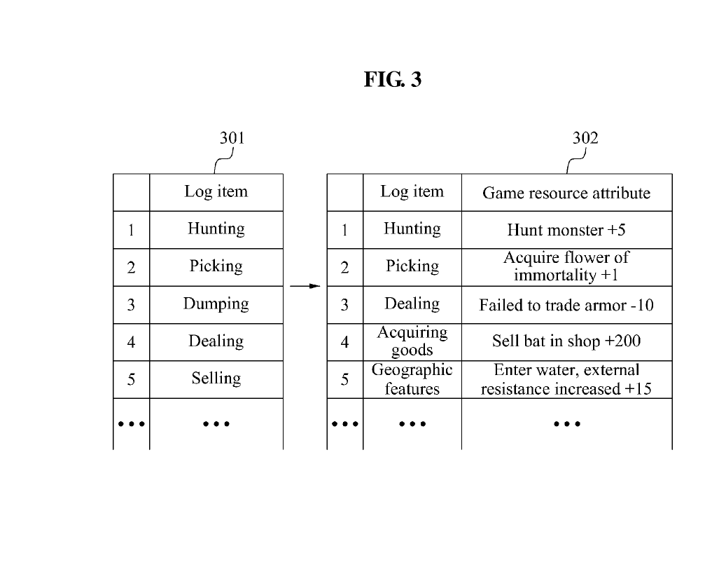

FIG. 3 illustrates a game resource attribute according to an exemplary embodiment.

Referring to FIG. 3, a game characteristics/attributes analysis apparatus may use a log of game play details. The log may include a log item 301. The log item 301 may include items based on game plays of a game user, such as hunting, picking, dumping, dealing, selling and trading. That is, the log item 301 may be an item for recording a game play detail or play result of the game user.

The game characteristics/attributes analysis apparatus may preprocess the log to generate log data. The game characteristics/attributes analysis apparatus may extract a game resource attribute 302 of the game user using the log data. Here, the game characteristics/attributes analysis apparatus may use a predefined game data schema related to a game or a predefined log item corresponding to the log data. The game characteristics/attributes analysis apparatus may analyze a game resource characteristic using various types of data defining game data, without being limited to the game data schema or the log item.

The game characteristics/attributes analysis apparatus may extract a game resource attribute 302 of each individual user. The game resource attribute 302 may be an attribute of a game resource that occurs when the game user plays the game. The game characteristics/attributes analysis apparatus may analyze may detect a characteristic of an cheating user based on the extracted game resource attribute. That is, the game characteristics/attributes analysis apparatus may classify game users into a game user acquiring goods in a normal manner and a game user acquiring goods in an illegal manner through the game resource attribute 302. For example, the game characteristics/attributes analysis apparatus may classify game users into a game user to acquire a flower of immortality +1 via a normal “picking” scheme in a normal manner and a game user to acquire a flower of immortality +5 via an illegal manner.

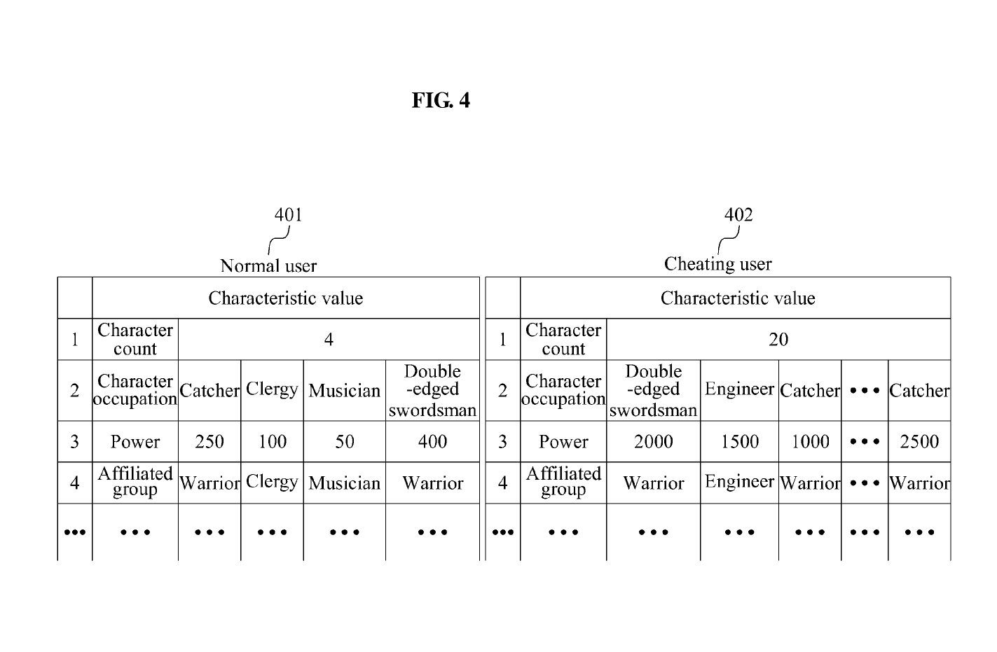

FIG. 4 illustrates characteristics of a normal user and an cheating user according to an exemplary embodiment.

Referring to FIG. 4, the game characteristics/attributes analysis apparatus may extract characteristics of a normal user 401 and an cheating user 402.

A characteristic of the normal user 401 may be extracted using an attribute of a game user. The attribute of the game user may include at least one of state settings and variable properties among a number of characters of the game user, occupations of the characters, ability of the characters to move, physical fitness, power, skills, an affiliated group in game, a connection state, interaction, a party, a guild and a raid. The attribute of the game user may include an attribute for categorizing the game user as a cluster that the game user belongs to. Also, the attribute of the game user may be a general property of the game user playing a game.

A characteristic of the cheating user 402 may be extracted by comparison with the characteristic of the normal user 401. In detail, the characteristic of the cheating user 402 may be extracted using a game resource characteristic for categorizing the game user as each cluster and the preprocessed log data. The characteristic of the cheating user 402 may be extracted using a function of comparing the characteristic of the normal user 401 and the characteristic of the cheating user 402.

The characteristic of the cheating user 402 may have the same structure as the attribute of the game user. Here, the characteristic of the cheating user 402 may be different from the characteristic of the normal user 401 due to goods acquired by an illegal manner. That is, the characteristic of the cheating user 402 may have a difference in a number of characters and power from a characteristic value based on the characteristic of the normal user 401. For example, when “a number of characters” based on the characteristic of the normal user 401 is four, “a number of characters” based on the characteristic of the cheating user 402 may be 20, which is remarkably different from “the number of characters” of the normal user 401.

Thus, the game characteristics/attributes analysis apparatus may detect the cheating user among the game users by comparing the characteristic of the normal user 401 and the characteristic of the cheating user 402.

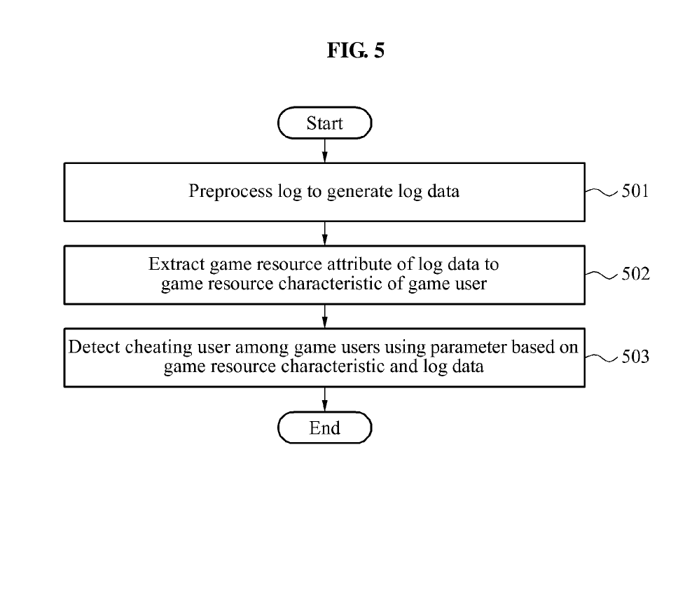

FIG. 5 illustrates a game characteristics/attributes analysis method according to an exemplary embodiment.

In operation 501, a game characteristics/attributes analysis apparatus may preprocess a log of game play details of a game user to generate log data. Here, the log may include a log item recording the game play details or play results, such as hunting, picking, dumping, dealing, selling and trading.

Preprocessing may include noise reduction, data sorting or data format conversion. In detail, noise reduction may be removing unnecessary data or items in the log, incorrectly recorded data or items in the log, and data or items disturbing detection of an cheating user. Data format conversion may be filling a blank item of data to adjust a data format. For example, data format conversion may be performed by filling a blank item of data with a preset character or character string, thereby converting a data format.

In operation 502, the game characteristics/attributes analysis apparatus may extract a game resource attribute of the log data to analyze a game resource characteristic of the game user. Here, the game characteristics/attributes analysis apparatus may analyze the game resource characteristic of the game user using a predefined game data schema related to a game or a predefined log item corresponding to the log data. Also, the game characteristics/attributes analysis apparatus may extract the game resource attribute that occurs in a process that the game user plays the game from the log item of the log data. The game resource attribute may refer to an attribute value of a game resource according to the log item.

Further, the game characteristics/attributes analysis apparatus may analyze a game resource characteristic related to an attribute value for categorizing the game user as a cluster that the game user belongs to. Categorizing may be sorting individual users into groups. A game resource characteristic may be distinguished from a game resource attribute and be a feature to categorize the game user.

In operation 503, the game characteristics/attributes analysis apparatus may extract a characteristic of a normal user among game users by using an attribute of the game user. Also, the game characteristics/attributes analysis apparatus may set up a function of comparing a characteristic of an cheating user using the game resource characteristic for categorizing the game user as each cluster and the preprocessed log data. Here, the game characteristics/attributes analysis apparatus may set up a function of comparing the characteristic of the normal user and the characteristic of the cheating user.

Further, the game characteristics/attributes analysis apparatus may set up a threshold and a parameter for adjusting the function or statistical scheme. Here, the threshold and the parameter may be set up based on the characteristic of the normal user. The game characteristics/attributes analysis apparatus may adjust the function based on the threshold and parameter, thereby detecting an cheating user among game users.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for analyzing a game characteristic, the apparatus comprising:
a log data generation unit to preprocess a log of game play details of game users to generate log data;
a characteristics analysis unit to extract a game resource attribute of the log data to analyze game resource characteristics of the game users; and
an cheating user detection unit to detect an cheating user of the game users using the game resource characteristics and the log data.

2. The apparatus of claim 1, wherein the log data generation unit preprocesses the log using at least one of noise reduction, data sorting, data format conversion and filling a blank item of data.

3. The apparatus of claim 1, wherein the characteristics analysis unit extracts the game resource attribute that occurs in a process that the game users play a game from a log item of the log data.

4. The apparatus of claim 1, wherein the game resource attribute comprises at least one of goods acquired or changed in holding state via a direct play including at least one of hunting, picking, dumping, collecting, dealing, selling, purchasing and producing that occur while the game users play a game, attributes and changes due to goods changed in holding state by acquiring and dumping, geographic features and natural features.

5. The apparatus of claim 1, wherein the characteristics analysis unit analyzes the game resource characteristics related to an attribute for categorizing the game users as a cluster that the game users belong to.

6. The apparatus of claim 1, wherein the cheating user detection unit extracts a characteristic of a normal user based on attributes of the game users.

7. The apparatus of claim 6, wherein the attributes of the game users comprise at least one of state settings and variable properties among a number of characters of the game users, occupations of the characters, ability of the characters to move, physical fitness, power, skills, an affiliated group in game, a connection state, interaction, a party, a guild and a raid.

8. The apparatus of claim 6, wherein the attributes of the game users comprise an attribute for categorizing the game users as a cluster that the game users belong to.

9. The apparatus of claim 6, wherein the cheating user detection unit sets up a function of comparing a characteristic of the cheating user with the characteristic of the normal user, and extracts a threshold and a parameter for adjusting the function.

10. A method of detecting a game characteristic, the method comprising:
preprocessing a log of game play details of game users, and generating log data;
extracting a game resource attribute of the log data, and analyzing game resource characteristics of the game users; and
detecting an cheating user of the game users using the game resource characteristics and the log data.

11. The method of claim 10, wherein the generating of the log data comprises preprocessing the log using at least one of noise reduction, data sorting, data format conversion and filling a blank item of data.

12. The method of claim 10, wherein the analyzing of the game resource characteristics comprises extracting the game resource attribute that occurs in a process that the game users play a game from a log item of the log data.

13. The method of claim 10, wherein the game resource attribute comprises at least one of goods acquired or changed in holding state via a direct play including at least one of hunting, picking, dumping, collecting, dealing, selling, purchasing and producing that occur while the game users play a game, attributes and changes due to goods changed in holding state by acquiring and dumping, geographic features and natural features.

14. The method of claim 10, wherein the analyzing of the game resource characteristics comprises analyzing the game resource characteristics related to an attribute for categorizing the game users as a cluster that the game users belong to.

15. The method of claim 10, wherein the detecting of the cheating user comprises extracting a characteristic of a normal user based on attributes of the game users.

16. The method of claim 15, wherein the attributes of the game users comprise at least one of state settings and variable properties among a number of characters of the game users, occupations of the characters, ability of the characters to move, physical fitness, power, skills, an affiliated group in game, a connection state, interaction, a party, a guild and a raid.

17. The method of claim 15, wherein the attributes of the game users comprise an attribute for categorizing the game users as a cluster that the game users belong to.

18. The method of claim 15, wherein the detecting of the cheating user comprises setting up a function of comparing a characteristic of the cheating user with the characteristic of the normal user and extracting a threshold and a parameter for adjusting the function.
